(19) United States
(12) Patent Application Publication
(10) Pub. No.: US 2007/0050450 A1
(43) Pub. Date: Mar. 1, 2007

(54) Interfacing an applet with a collaboration program

(75) Inventors: Todd R. Manion, Redmond, WA (US); Kanaka Komandur, Redmond, WA (US); Peter Williamson, Kirkland, WA (US); Ryan Kim, Sammamish, WA (US); R. Scott Briggs, Redmond, WA (US); Eliot John Flannery, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/214,070

(22) Filed: Aug. 29, 2005

(51) Int. Cl. G06F 15/16

(52) U.S. Cl. 709/204

(57) ABSTRACT

A method of interfacing applets with a collaboration program is disclosed. The method may be in the form of application programming interface calls.

### BACKGROUND

Meetings are one of the main places people collaborate with each other. Unfortunately, most of the collaboration takes place outside of the constraints of a computer. Collaborating together in the context of a meeting on the computer is an arduous task. An electronic meeting or collaboration space seeks to ease and enhance the collaboration done for meetings. More specifically it seeks to address the following pain points: Organizing, inviting, and viewing participants, linking multiple activities, summarizing and saving the meeting and supporting “foreign” environments such as customer sites, hotspots, etc. with little or no infrastructure.

### SUMMARY

A method of interfacing applets with a collaboration program is disclosed. The method may be in the form of application programming interface calls. The calls may allow an applet to execute the minimum functions to make adding an applet to a collaboration program easier, such as allowing the first applet to call an option that returns the location where shared files are stored locally, to call an option that returns the location where shared files are stored locally, to call an option that returns a handle to the group, to call an option that allow the first applet to register or unregister itself as part of the collaboration program so that the first applet is available as part of the collaboration program. In addition, the method allows the first applet to be installed or uninstall as part of the collaboration program menu, to call an option that allows the first applet to register or unregister to receive a particular type of notification, to call an option that allows the first applet to display on a user interface of the collaboration program that the first applet has been added.

### DRAWINGS

FIG. 1 is a block diagram of a computing system that may operate in accordance with the claims;

FIG. 2 is a representation of a computer display showing a version of a collaboration meeting window;

FIG. 3 is a method of starting, holding and ending an on-line meeting; and

FIG. 4 is a method of interfacing an applet into a collaboration program.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

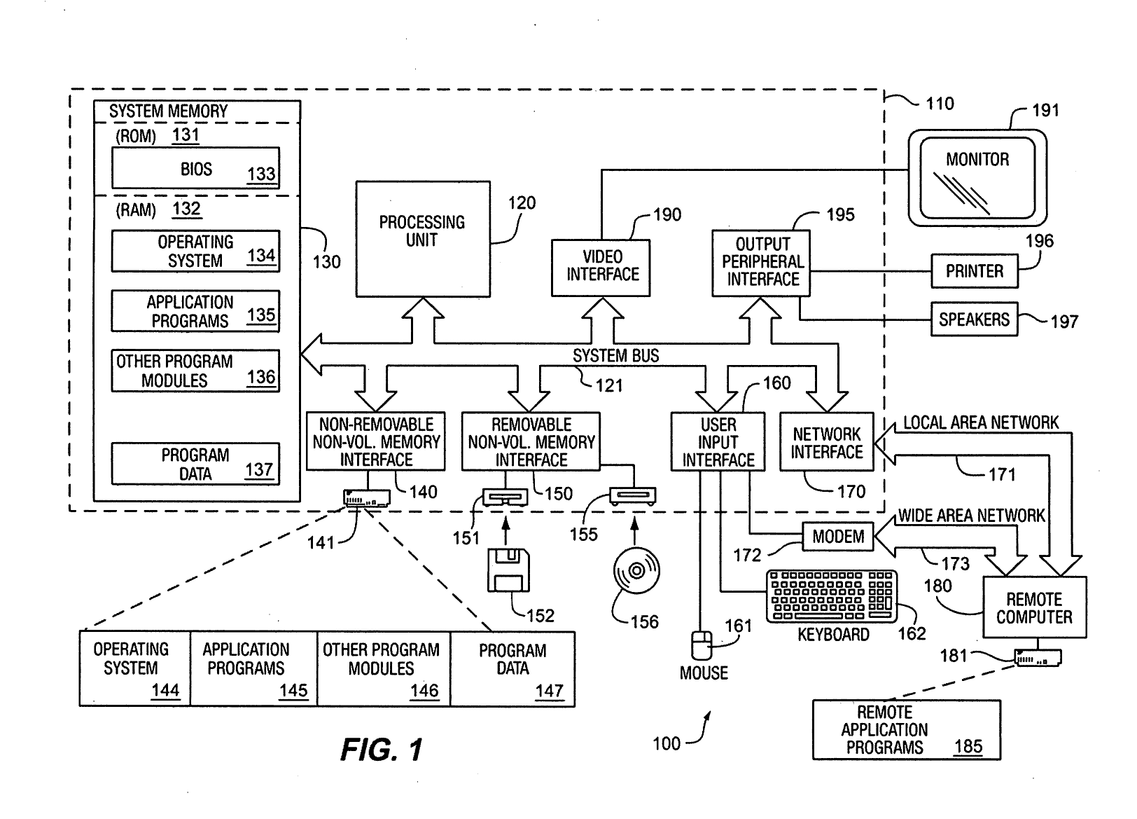

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Collaboration in the electronic frontier sounds simple, but has been difficult to implement. Ideally, electronic meetings would simulate the activities that occur in live physical meetings such as inviting attendees, sending out an agenda, presenting documents for all attendees to view and discuss, allowing additional thinking on the topics at hand and saving the results of the meeting in some form. One way to encourage electronic meetings is to create easy to use methods to implement electronic meetings. Further, once the methods of implementing electronic meetings are known, creating easy to use methods to interface additional applets or program part with the underlying electronic meeting method can produce further innovation. The electronic meetings may be in a computer based peer to peer environment or in a server based computer environment.

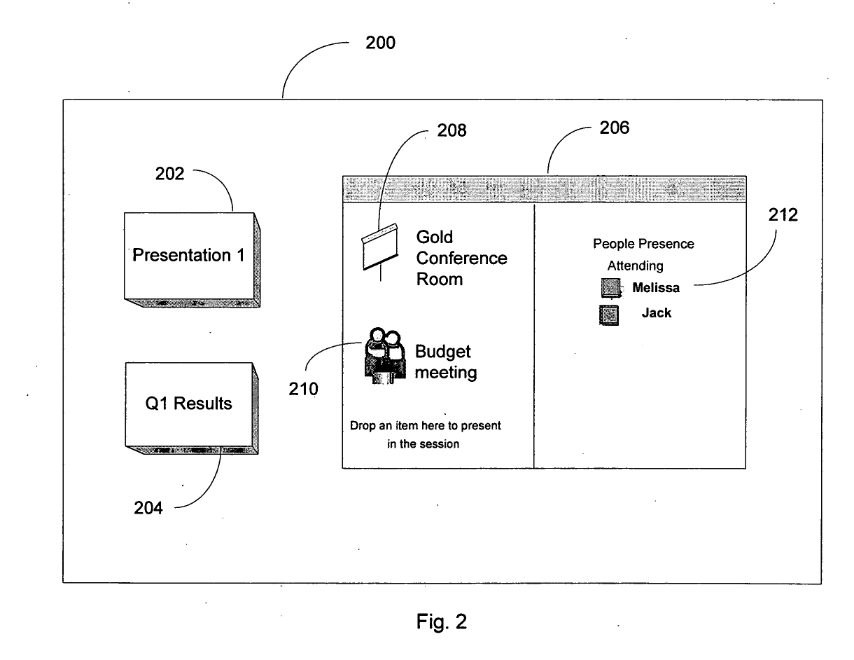

FIG. 2 depicts a computer display 200 representing a display associated with an electronic collaboration meeting, such as may be seen on monitor 191 of computer 110 of FIG. 1. The screen data 200 may include first icons representing data, such as icon 202 titled, “Presentation 1” and icon 204 titled, “Q1 results.” The first icons 202 204 may be associated with a variety of application programs. Such programs may include a word processor, a multimedia player, a presentation manager or a file viewer, for example a portable data format (.pdf) file viewer. The first icons 202 204 may also represent the applications themselves apart from data created with the application. A window 206 associated with a meeting may contain second icons associated with networked resources. Second icon 208 may represent projection equipment in the “Gold” conference room. Second icon 210 may represent all persons presently in attendance at the meeting, for example, an on-line meeting over a peer-to-peer network. A second frame 212 may represent all attendees currently involved in a particular on-line meeting. In one embodiment, selecting, dragging and dropping one of the first icons, for example, first icon 202 representing a presentation, onto icon 210, representing attendees at the current meeting would cause the presentation to be streamed to the selected attendees. Similarly, first icon 204 labeled “Q1 Results,” may be dragged onto second icon 208 to initiate the presentation of the Q1 Results slides on the projector in the gold conference room. To the local user, that is, the presenter, the effect is similar to opening and viewing the file. An application program associated with the first icon, for example, Microsoft PowerPoint™, may be activated when the data from the file represented by the first icon 200 204 is displayed. As discussed below, meeting attendees will see the presentation file streamed from the presenter, for example, in the left-hand pane of the meeting window 206.

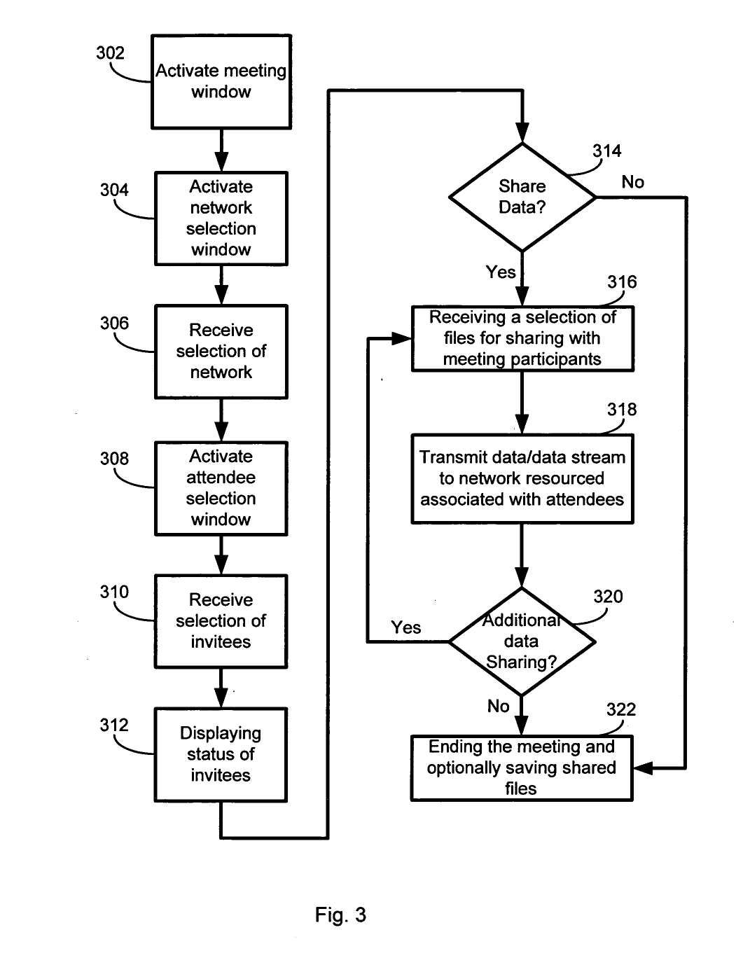

FIG. 3, an exemplary method of holding an online collaboration meeting over a network, such as a peer-to-peer network, is discussed and described. When a computer user has decided to hold a meeting, he or she may activate 302 a meeting window. They may then activate 304 a window for network selection. A variety of network selections may be available. For example, computers, and therefore their associated users, present on a local network such as a local Internet Protocol (IP) subnet may be displayed for selection. The use of an IP subnet for providing a selection of meeting attendees relies on the notion that in many cases the physical topology of a network follows the organization of the people on the network. Alternatively, in one embodiment, network selection may take advantage of ad hoc networking (an abstract term that may refer to communication over a self-configuring network and is not limited to any particular wireless network or even to wireless networks only). Such capability allows nearby users to form their own private networks without regard to a larger network infrastructure, such as wireless access points, backbones and routers.

When a selection of network is received 306, an attendee selection window may be activated 308. The attendee selection window may aggregates all potential attendees from all the available network connections. The meeting creator may choose to host the meeting on only a single network (typically an ad hoc network) in which case attendees may connect to that network in order to join the meeting or can choose to make the meeting network agnostic, in which case attendees that are connected to any of the networks that the meeting creator is connected to can join the meeting. Attendees may be selected from a variety of groups or lists of individuals. For example, a buddy list used for Instant Messaging (IM) may provide names for selection. Personal, local, and network-based, for example corporate, address books may be used to supply names for selection. Additional selections may be made from persons recently invited to other meetings. After receiving 310 the selection of users, invitations, may be forwarded to the invitees. Invitee status may be displayed 312, showing those in attendance, those who have not arrived, or those who have declined (not depicted).

Once the meeting is active, multiple activities may be performed. Often it is desirable to distribute materials to meeting participants. The application associated with the meeting may provide, as discussed above, the capability to receive 314 a selection of whether to share data or files with meeting participants. If the choice is to share files, the ‘yes’ branch of block 314 may be followed. A selection of files for sharing may be received 316 by the application. The selection may be for distribution of files or for streaming of presentation data. Familiar menu pick or drag-and-drop methods are two examples of ways to introduce files for sharing with meeting participants. Once identified, known peer-to-peer network services, such as a file replication service, may be used to distribute 318 the selected data to current participants as well as updating newly added participants. When the selection is to stream presentation data, an appropriate application program may be activated, if needed, and output data associated with the presentation may be distributed 318 to participating computers. In addition, certain network devices such as network accessible projectors may also be designated as targets of the presentation data stream. If additional presentation materials or data files are to be shared, the ‘yes’ branch from block 320 may be followed and the process repeated.

If no data is shared at block 314, the ‘no’ branch may be followed to block 322. Similarly, when no more data is to be shared, the ‘no’ branch from 320 may be followed to block 322. The meeting may proceed as normal to a conclusion.

At the conclusion of the meeting (or earlier), participants may leave 322 the meeting. Participants may have the opportunity to save any files that were shared during the meeting process or alternatively to discard those files to limit the possibility of version confusion in the future.

The meeting application described and its associated user interface brings new features and capabilities to meeting organizers and meeting attendees. The simple organization of the meeting window and special function panes reduce the overhead associated with inviting, attending, sharing files, and presenting live data during a meeting. The use of peer-to-peer network data streaming for presentations should simplify the processes currently available for viewing presentation materials.

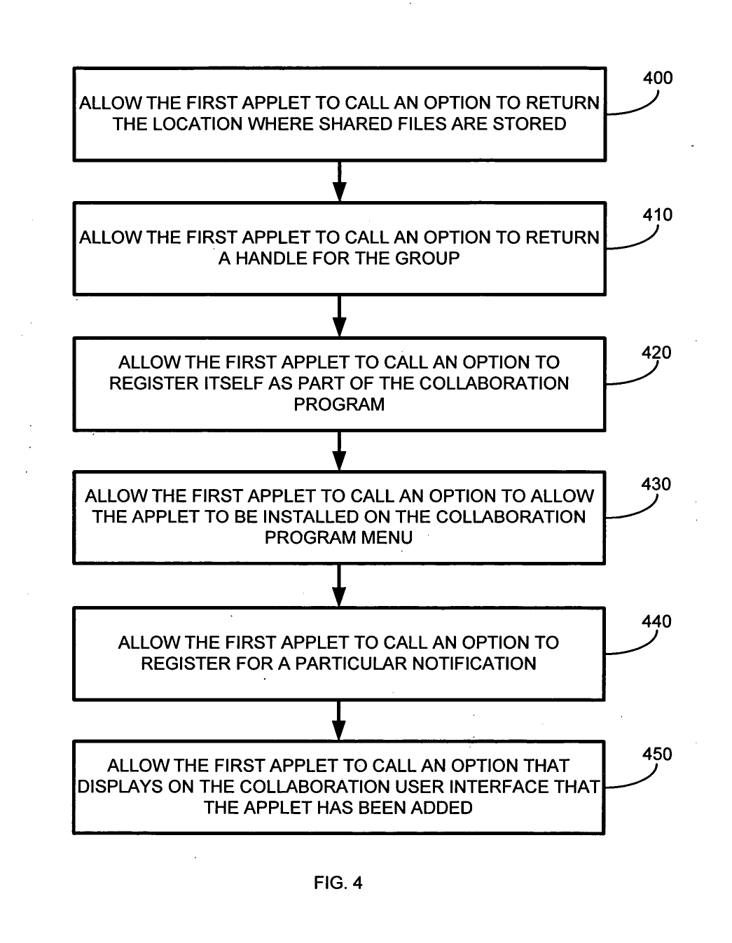

FIG. 4 may be an illustration of a method of interfacing a first applet with a computer based collaboration program and other applets registered with the collaboration program for a group of users in accordance with the claims. For example, a collaboration program may exist and may have a registered calendar applet. A new applet for tracking the weather may interface with the collaboration program and the already registered calendar applet. In an alternative embodiment, the first applet may only have to register with the collaboration program.

The method may be implemented using application programming interface (“API”) calls. An API may be a language and message format used by an application program to communicate with the operating system or some other control program such as a database management system (DBMS) or communications protocol. APIs are implemented by writing function calls in the program, which provide the linkage to the required subroutine for execution. Thus, an API implies that some program module is available in the computer to perform the operation or that it must be linked into the existing program to perform the tasks

At block 400, the method may allow the first applet to call an option that returns the location where shared files used by the collaboration space program are stored locally. Accordingly, an application developer or applet created by a developer may be able to get the root share associated with the collaboration space. By having the root share, other applets may manage files associated with a meeting. A sample call may be as follows:

HRESULT PeerSpaceGetShareRoot([out] ShareRoot).

At block 410, the method may allow the first applet to call an option that returns a handle to the group, wherein the handle identifies the group. The handle may be a numeric identifier of a group. This call may return a group such as a PeerGroup associated with the meeting. With the handle, the user can utilize a peer to peer (“P2P”) API to interact with the group. A sample call may be as follows:

HRESULT PeerSpaceGetPeerGroup([out] HGROUP).

At block 420, the method may allow the first applet to call an option that allows the first applet to install itself as part of the collaboration program so that the first applet is available as part of the collaboration program such as presentation 1,202 or Q1 Results 204 in FIG. 2. This call may allow an applet or part to be registered with the collaboration program. It may provide a mechanism for an applet or part to “install” itself so a user can utilize the applet inside the collaboration space. A sample call may be as follows:

HRESULT PeerSpaceRegisterPart([in] Part).

If the first applet has been registered, the method may allow the first applet to call an unregister option that allows the first applet to uninstall itself as part of the collaboration program so that a user will not be able to utilize the first applet as part of the collaboration program. A sample call may be as follows:

HRESULT PeerSpaceUnregisterPart([in] Part)].

At block 430, the method may allow the first applet to call an add menu option that allows the first applet to be installed as part of the collaboration program menu. This API adds a particular menu item and handler to a specific part. A sample call may be as follows:

HRESULT PeerSpacePartAddMainMenuItem([in] MenuItem).

If a menu option has been added, the method may also allow the applet to call a remove menu option. The remove option may allow an applet to be uninstalled as part of the collaboration program menu. A sample call may be as follows:

HRESULT PeerSpacePartRemoveMainMenuItem([in] MenuItem).

At block 440, the method may allow the first applet to call a register notification option that allows the first applet to receive a particular type of notification. This notification could be a standard notification or a specific part notification. A sample call may be as follows:

HRESULT PeerSpaceRegisterNotification([in] NotificationID).

If the applet has been registered for particular notification, the method may allow the applet to call an unregister notification option that allows the applet to stop receiving a particular type of notification. For example, older applets may be informed of new applets that register with the collaboration program. A sample call may be as follows:

HRESULT PeerSpaceUnregisterNotification([in] NotificationID).

At block 450, the method may allow the first applet to call an option that allows the first applet to display on a user interface of the collaboration program that the first applet has been added. This pops-up an “in meeting” notification for the user to see. A sample call may be as follows:

HRESULT PeerSpaceShowNotification([in] Notification).

In addition, the method may allow the first applet to call an option that allow the first applet to ask the other registered applets what objects they are making available. An example may be the presence applet. Other applets could query the presence applet for the contact objects associated with the presence applet. A sample query may be as follows:

HRESULT PeerSpacePartGetAvailableObjects([out] Objects).

The method may allow the first applet to call an option that allows for other applets to query the first applet regarding what notifications the first applet is making available. An example would be the presence applet where other applets could query the applet for the state changes of a particular contact. A sample call may be as follows:

HRESULT PeerSpaceGetAvailableNotifications([out] NotificationID).

The method may allow the applet to call a notification option that allows the applet to inform all other registered applets that a new applet has been installed. All registered notifications may be then signaled as a result. A sample call may be as follows:

HRESULT PeerSpaceTriggerNotification([in] NotificationID, [in] NotificationData).

The method may allow the applet to call an option that allows additional information about an applet to be access by right clicking an applet icon. This call may add a particular context menu item and handler to a specific part/object pair. A sample call may be as follows:

HRESULT PeerSpaceAddContextMenuItem([in] ContextMenuItem, [in] Handler).

If a right click menu option has been called, the method may allow the applet to call an option to remove the right click icon. This call may remove a particular context menu item and handler to a specific part/object pair. A sample call may be as follows:

[HRESULT PeerSpaceRemoveContextMenuItem([in] ContextMenuItem).

Of course, additional calls are available and may make sense as part of the method. Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of interfacing a first applet with a computer based collaboration program and other applets registered with the collaboration program for a group of users comprising:
allowing the first applet to call an option that returns the location where shared files are stored locally;
allowing the first applet to call an option that returns a handle to the group, wherein the handle identifies the group;
allowing the first applet to call an option that allow the first applet to register itself as part of the collaboration program so that the first applet is available as part of the collaboration program;
allowing the first applet to call an option that allows the first applet to be installed as part of the collaboration program menu;
allowing the first applet to call an option that allows the first applet to register to receive a particular type of notification; and
allowing the first applet to call an option that allows the first applet to display on a user interface of the collaboration program that the first applet has been added.

2. The method of claim 1, further comprising allowing the first applet to call an option that allow the first applet to ask the other registered applets what objects are available.

3. The method of claim 1, further comprising allowing the first applet to call an option that allows for other applets to query the first applet regarding what notifications the first applet is making available.

4. The method of claim 1, further comprising if the first applet has been registered, allowing the first applet to call an unregister option that allows the first applet to uninstall itself as part of the collaboration program so that a user will not be able to utilize the first applet as part of the collaboration program.

5. The method of claim 1, further comprising if the applet has been registered for particular notification, allowing the applet to call an unregister notification option that allows the applet to stop receiving a particular type of notification.

6. The method of claim 1, further comprising allowing the applet to call a notification option that allows the applet to inform all other registered applets that a new applet has been installed.

7. The method of claim 1, further comprising allowing the applet to call a remove menu option that allows an applet to be uninstalled as part of the collaboration program menu.

8. The method of claim 1, further comprising allowing the applet to call an option that allows additional information about an applet to be access by right clicking an applet icon.

9. The method of claim 8, further comprising if an option to add a right click menu item has been called, allowing the applet to call an option to remove the right click menu item.

10. The method of claim 1, wherein the handle is a numeric identifier of a group.

11. A computer readable medium comprising computer executable instructions for performing a method of interfacing a first applet with a computer based collaboration program and other applets registered with the collaboration program for a group of users comprising:
allowing the first applet to call an option that returns the location where shared files are stored locally;
allowing the first applet to call an option that returns a handle to the group, wherein the handle is a numeric identifier for the group;
allowing the first applet to call an option that allow the first applet to register itself as part of the collaboration program so that the first applet is available as part of the collaboration program;
if the first applet has been registered, allowing the first applet to call an unregister option that allows the first applet to uninstall itself as part of the collaboration program so that a user will not be able to utilize the first applet as part of the collaboration program;
allowing the first applet to call an option that allows the first applet to be installed as part of the collaboration program menu;
if the first applet has been installed as part of the collaboration program, allowing the first applet to call an option that allows the first applet to be uninstalled as part of the collaboration program menu;
allowing the first applet to call an option that allows the first applet to register to receive a particular type of notification; and
allowing the first applet to call an option that allows the first applet to display on a user interface of the collaboration program that the first applet has been added.

12. The method of claim 11, further comprising allowing the first applet to call an option that allow the first applet to ask the other registered applets what objects are available.

13. The method of claim 11, further comprising allowing the first applet to call an option that allows for other applets to query the first applet regarding what notifications the first applet is making available.

14. The method of claim 11, further comprising if the applet has been registered for particular notification, allowing the applet to call an unregister notification option that allows the applet to stop receiving a particular type of notification.

15. The method of claim 11, further comprising allowing the applet to call a notification option that allows the applet to inform all other registered applets that a new applet has been installed.

16. The method of claim 11, further comprising allowing the applet to call an option that allows additional information about an applet to be access by right clicking an applet icon and if the add right click menu option has been called, allowing the applet to call an option to remove the right menu item.

17. An application programming interface comprising function calls for interfacing a first applet with a computer based collaboration program and other applets registered with the collaboration program for a group of users comprising:
allowing the first applet to call an option that returns the location where shared files are stored locally;
allowing the first applet to call an option that returns the location where shared files are stored locally;
allowing the first applet to call an option that returns a handle to the group, wherein the handle is a numeric identifier for the group;
allowing the first applet to call an option that allow the first applet to register itself as part of the collaboration program so that the first applet is available as part of the collaboration program;
if the first applet has been registered, allowing the first applet to call an unregister option that allows the first applet to uninstall itself as part of the collaboration program so that a user will not be able to utilize the first applet as part of the collaboration program;
allowing the first applet to call an option that allows the first applet to be installed as part of the collaboration program menu;
if the first applet has been installed as part of the collaboration program, allowing the first applet to call an option that allows the first applet to be uninstalled as part of the collaboration program menu;
allowing the first applet to call an option that allows the first applet to register to receive a particular type of notification;
if the first applet has been registered for particular notification, allowing the applet to call an unregister notification option that allows the applet to stop receiving a particular type of notification
allowing the first applet to call an option that allows the first applet to display on a user interface of the collaboration program that the first applet has been added;
allowing the first applet to call an option that allows the first applet to ask the other registered applets what objects are available;
allowing the first applet to call an option that allows for other applets to query the first applet regarding what notifications the first applet is making available.

18. The application programming interface of claim 17, further comprising allowing the applet to call a notification option that allows the applet to inform all other registered applets that a new applet has been installed.

19. The application programming interface of claim 17, further comprising allowing the applet to call an option that allows additional information about an applet to be access by right clicking an applet icon and if the add right click menu option has been called, allowing the applet to call an option to remove the right click icon.
